(19) United States
(12) Patent Application Publication
(10) Pub. No.: US 2016/0116754 A1
(43) Pub. Date: Apr. 28, 2016

(54) Dielectric Polarizing Beam Splitter

(71) Applicant: Moxtek, Inc., Orem, UT (US)

(72) Inventor: Bin Wang, Lindon, UT (US)

(21) Appl. No.: 14/841,234

(22) Filed: Aug. 31, 2015

Related U.S. Application Data
(60) Provisional application No. 62/097,476, filed on Dec. 29, 2014.
(60) Provisional application No. 62/069,649, filed on Oct. 28, 2014.

(51) Int. Cl. G02B 27/28; G02B 5/30; G02B 5/18

(52) U.S. Cl. CPC G02B 27/283; G02B 5/1833; G02B 5/3083

(57) ABSTRACT

The invention is a dielectric polarizing beam splitter including a grating-layer disposed over a substantially planar surface of a substrate. The grating-layer can include an array of elongated, substantially-parallel alternating high-index regions and low-index regions. An index of refraction (n_{L}) of the low-index-regions can be less than an index of refraction (n_{H}) of the high-index-regions.

### CLAIM OF PRIORITY

This claims priority to U.S. Provisional Patent Application Nos. 62/069,649, filed on Oct. 28, 2014, and 62/097,476, filed on Dec. 29, 2014, which are hereby incorporated herein by reference in their entirety.

### FIELD OF THE INVENTION

The present application is related generally to an optical device called a polarizing beam splitter or reflective wire grid polarizer.

### BACKGROUND

Many optical systems require use of polarized light. Polarizing beam splitters can divide the light into two, opposite polarization states. Each type of polarizing beam splitter has its disadvantages. MacNeille prisms can have a disadvantage of a small range of light incident angles. Wire grid polarizing beam splitter plates can allow a much broader range of light incident angles than MacNeille prisms, but can have disadvantages of relatively low efficiency, long back-focal-length in an optical system, and difficulty of assembly into an optical system due to their fragile nature. Some wire grid polarizing beam splitters in cubes can overcome the back focal length and assembly problems of wire grid polarizing beam splitter plates, but can have worse efficiency than wire grid polarizing beam splitter plates. Materials used in polarizers typically absorb a substantial amount of light. In some applications, it is important to minimize any loss of light due to absorption.

### SUMMARY

It has been recognized that it would be advantageous to provide a polarizing beam splitter with a broad range of light incident angles, high transmission of one polarization (e.g. high Tp), high or controlled reflection of an opposite polarization (e.g. high Rs, or Rs controlled to a desired value), high efficiency, short back-focal-length in an optical system, ease of assembly into an optical system, and minimal loss of light due to absorption. The present invention is directed to various embodiments of dielectric polarizing beam splitters (PBS) for the visible spectrum that satisfy these needs. Each embodiment may satisfy one, some, or all of these needs. The PBS can comprise a grating-layer disposed over a substantially planar surface of a substrate. The grating-layer can include an array of elongated, substantially-parallel, alternating high-index regions and low-index regions.

### BRIEF DESCRIPTION OF THE DRAWINGS

FIGS. 1-3 are schematic cross-sectional side views of dielectric polarizing beam splitters, in accordance with embodiments of the present invention;

FIG. 4 is a schematic perspective view of a dielectric polarizing beam splitter, showing non-normal incident light L_{xz} at angle θ_{xz} in the x-z plane, in accordance with an embodiment of the present invention;

FIG. 5 is a schematic perspective view of a dielectric polarizing beam splitter, showing non-normal incident light L_{yz} at angle θ_{yz} in the y-z plane, in accordance with an embodiment of the present invention;

FIG. 6 is a schematic view of a light-beam splitting system, in accordance with an embodiment of the present invention;

FIGS. 7-11 are schematic cross-sectional side views illustrating a first method of making a dielectric polarizing beam splitter, in accordance with an embodiment of the present invention; and

FIGS. 12-14 are schematic cross-sectional side views illustrating a second method of making a dielectric polarizing beam splitter, in accordance with an embodiment of the present invention.

### DEFINITIONS

As used herein, the term “contrast” means transmission of a desired polarization (e.g. Tp) divided by transmission of an opposite polarization (e.g. Ts). Thus, contrast can equal Tp/Ts.

As used herein, the term “efficiency” means transmission of one polarization (e.g. Tp) times reflection of an opposite polarization (e.g. Rs). Thus, efficiency can equal Tp*Rs.

As used herein, the term “elongated”, with regard to the high-index regions 13_{H} and the low-index regions 13_{L}, means a length L that is substantially longer than a width W_{L} of the low-index regions 13_{L} (L>>W_{L}) and longer than a width W_{H} of the high-index regions 13_{H} (L>>W_{H}). For example, the length L can be at least 10 times longer than the widths W_{H} and W_{L} in one aspect, at least 100 times longer than the widths W_{H} and W_{L} in another aspect, or at least 1000 times longer than the widths W_{H} and W_{L} in another aspect.

As used herein, the term “polarizing beam splitter” or “PBS” means a polarizer that can substantially transmit one polarization and can substantially reflect an opposite polarization of light incident from various angles, including perpendicular to a planar surface of the substrate. For example, the PBS can transmit at least 70% of one polarization and can reflect at least 30% of an opposite polarization in one aspect or can transmit at least 80% of one polarization and can reflect at least 80% of an opposite polarization in another aspect.

As used herein, the term “thin-film-layer” means a continuous layer that is not divided into a grid.

### DETAILED DESCRIPTION

Traditionally, metals (e.g. aluminum) are used as polarizing wires in the visible spectrum. Such polarizers with metal polarizing wires can be relatively easy to make, can provide relatively high contrast, and can provide high transmission of a desired polarization (e.g. high Tp). Metals, such as aluminum, in such polarizers can absorb a substantial amount of light. For example, aluminum has a k value of about 4.8 through 8.4 throughout the visible spectrum. For some polarizer uses, this absorption is highly undesirable.

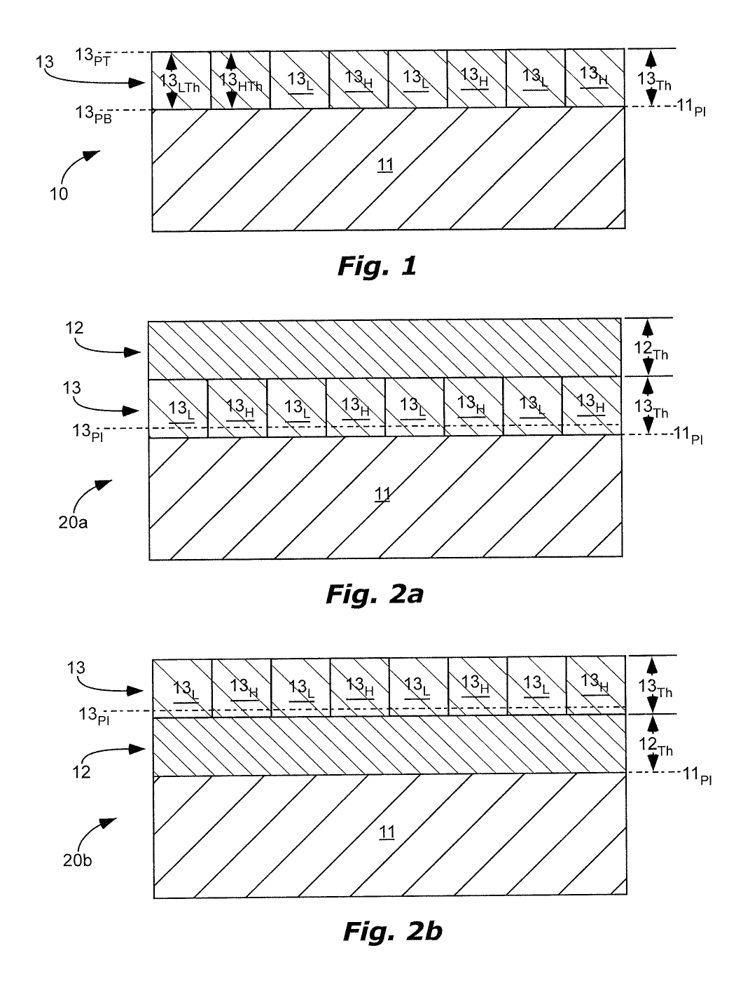

Illustrated in FIGS. 1-5 are dielectric polarizing beam splitters (PBS) 10, 20a, 20b, 30, and 40 and can be made mostly, substantially, or entirely of dielectric materials that are substantially transmissive to light in the wavelength range of use (e.g. low k value/extinction coefficient). This can avoid light loss due to absorption. This can be a very important feature for some applications. PBS 10, 20a, 20b, 30, and 40 can be made for use in the visible spectrum, or other regions of electromagnetic radiation.

PBS 10, 20a, 20b, 30, and 40 include a grating-layer 13, which can be located over a substantially planar surface 11_{Pl} of a substrate 11. The grating-layer 13 can include an array of elongated, substantially-parallel, alternating high-index regions 13_{H} and low-index regions 13_{L}. The grating-layer 13 can be located in a plane 13_{Pl} that is substantially parallel with the planar surface 11_{Pl} of the substrate 11.

The high-index regions 13_{H} can be made of a different dielectric material than the low-index regions 13_{L} and there can be a distinct boundary layer between these different materials. The high-index regions 13_{H} can be made of a solid dielectric material. The low-index regions 13_{L} can comprise a solid dielectric material, air, another gas, or vacuum. The array of elongated, substantially-parallel high-index regions 13_{H} and low-index regions 13_{L} can be an ordered, repeating array.

It can be beneficial, for improving efficiency of the dielectric PBS 10, 20a, 20b, 30, and 40, for an index of refraction n_{L} of the low-index-regions 13_{L} to be substantially less than an index of refraction n_{H} of the high-index-regions 13_{H}. For example, a difference between the index of refraction n_{H} of the high-index-regions 13_{H} and the index of refraction n_{L} of the low-index-regions 13_{L} can be greater than 0.3 in one aspect (n_{H}−n_{L}>0.3), greater than 1.0 in another aspect (n_{H}−n_{L}>1.0), greater than 1.3 in another aspect (n_{H}−n_{L}>1.3), greater than 1.5 in another aspect (n_{H}−n_{L}>1.5), or greater than 1.7 in another aspect (n_{H}−n_{L}>1.7) across the wavelength range of intended use (e.g. across the visible light spectrum). Choice of a material for the high-index-regions 13_{H} that has a large index of refraction n_{H} (e.g. greater 2.0, greater than 2.3, or greater than 2.5 across the visible spectrum) can improve PBS 10, 20a, 20b, 30, and 40 design.

It can also be beneficial, for improving efficiency of the dielectric PBS 10, 20a, 20b, 30, and 40, for one of the following two conditions (1 or 2) to be satisfied:
1. A large difference between an index of refraction n_{sub} of the substrate 11 and an effective index of refraction n_{∥} of the grating-layer 13 for a polarization parallel to a length L of the regions 13_{H} and 13_{L} AND a small difference between the index of refraction n_{sub} of the substrate 11 and an effective index of refraction n_{⊥} of the grating-layer 13 for a polarization perpendicular to a length L of the regions 13_{H} and 13_{L}. For example, the grating-layer 13 and substrate 11 can satisfy the equations:

|n_{sub}−n_{∥}|>0.3, |n_{sub}−n_{∥}|>0.45, |n_{sub}−n_{∥}|>0.6, |n_{sub}−n_{∥}|>0.7, or |n_{sub}−n_{∥}|>0.8, and a.

|n_{sub}−n_{⊥}|<0.25, |n_{sub}−n_{⊥}|<0.2, |n_{sub}−n_{⊥}|<0.15, |n_{sub}−n_{⊥}|<0.1, or |n_{sub}−n_{⊥}|<0.05. b.
2. A large difference between an index of refraction n_{sub} of the substrate 11 and an effective index of refraction n_{⊥} of the grating-layer 13 for a polarization perpendicular to a length L of the regions 13_{H} and 13_{L} AND a small difference between the index of refraction n_{sub} of the substrate 11 and an effective index of refraction n_{∥} of the grating-layer 13 for a polarization parallel to a length L of the regions 13_{H} and 13_{L}. For example, the grating-layer 13 and substrate 11 can satisfy the equations:

|n_{sub}−n_{⊥}|>0.3, |n_{sub}−n_{⊥}|>0.45, |n_{sub}−n_{⊥}|>0.6, |n_{sub}−n_{⊥}|>0.7, or |n_{sub}−n_{⊥}|>0.8, and a.

|n_{sub}−n_{∥}|<0.25, |n_{sub}−n_{∥}|<0.2, |n_{sub}−n_{∥}|<0.15, |n_{sub}−n_{∥}|<0.1, or |n_{sub}−n_{∥}|<0.05. b.

Duty cycle (W_{H}/P), n_{sub}, n_{H} and n_{L} can be selected to achieve desired relationships in equations 1.a, 1.b, 2.a, and 2.b above.

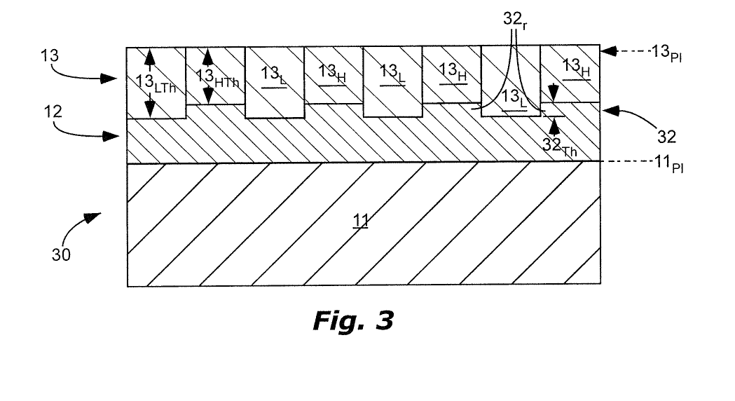

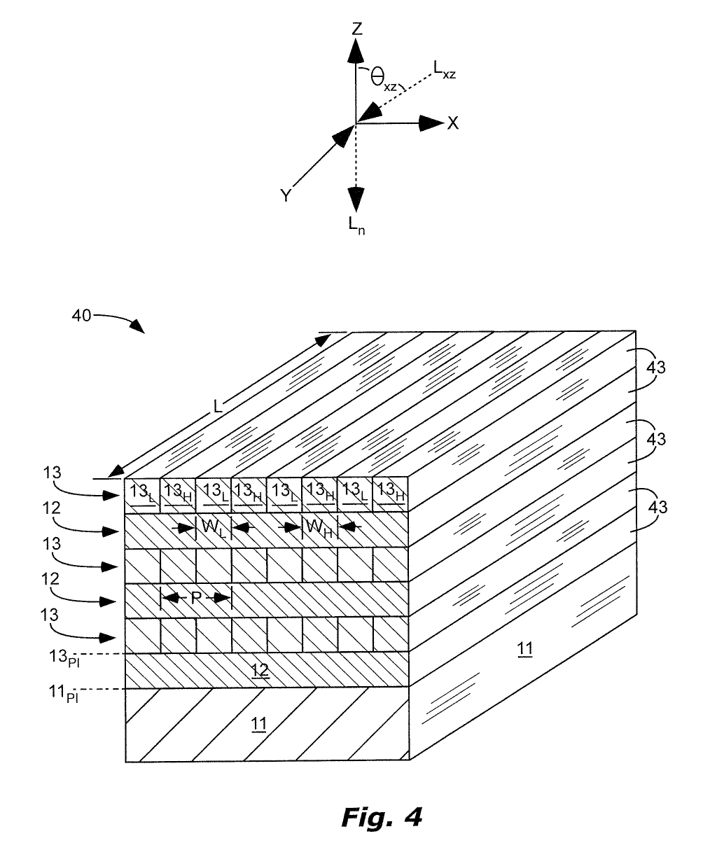

The effective indices of refraction n_{∥} & n_{⊥} of the grating-layer 13 can be approximated by the following equations for normal incident light Lₙ (θ=0, see FIGS. 4-5):

$$\begin{matrix}1. & {n}_{‖} = {( \frac{{W}_{L}}{P} * {n}_{L}^{2} + \frac{{W}_{H}}{P} * {n}_{H}^{2} )}^{1 / 2} \\ 2. & {n}_{⊥} = {( \frac{{W}_{L}}{P} * \frac{1}{{n}_{L}^{2}} + \frac{{W}_{H}}{P} * \frac{1}{{n}_{H}^{2}} )}^{- 1 / 2}\end{matrix}$$

W_{L} is a width of the low-index-regions 13_{L}. W_{H} is a width of the high-index-regions 13_{H}. P is a pitch of the high-index regions 13_{H}.

For non-normal incident light, angle θ is relative to the z axis and angle θ_{xz} is in the x-z plane (the plane that bisects the regions 13_{H} and 13_{L}, defining the plane of incidence). For non-normal incident light L_{xz} at angle θ_{xz} (see FIG. 4), the effective index of refraction n_{∥}(θ_{xz}) of the grating-layer 13 for a polarization perpendicular to the plane of incidence is not affected by the incident angle θ_{xz}. Thus, n_{∥}(θ_{xz})=n_{∥}. The effective index of refraction n_{⊥}(θ_{xz}) of the grating-layer 13 for a polarization parallel to the plane of incidence is, however, dependent on incident angle θ_{xz}. An equation approximating this effective index of refraction n_{⊥}(θ_{xz}) at angle of incidence θ_{xz} is: n_{⊥}(θ_{xz})=

$$\frac{{n}_{‖}^{2} {n}_{⊥}^{2}}{{n}_{‖}^{2} {cos}^{2} ( θ xz ) + {n}_{⊥}^{2} {sin}^{2} ( θ xz )} .$$

For non-normal incident light L_{yz} at angle θ_{yz} (see FIG. 5) in the y-z plane (the plane that is parallel to the regions 13_{H} and 13_{L}, defining the plane of incidence), the effective index of refraction n_{⊥}(θ_{yz}) of the grating-layer 13 for a polarization in the plane of incidence and the effective index of refraction n_{⊥}(θ_{yz}) of the grating-layer 13 for a polarization perpendicular to the plane of incidence are not affected by the incident angle θ. Thus, n_{∥}(θ_{yz})=n_{∥} and n_{⊥}(θ_{yz})=n_{⊥}.

PBS 10 (FIG. 1) is a simple dielectric PBS with only a single grating-layer 13 on the substrate 11 and no other layers. This PBS can have advantages of low manufacturing cost and very low absorption of light, but can have the disadvantage of low contrast. Efficiency can be improved by addition of a properly designed thin-film-layer 12 (see PBS 20a, 20b, 30, and 40).

A small difference between an index of refraction n_{TF} of the thin-film-layer 12 and an index of refraction n_{sub} of the substrate 11 can improve dielectric PBS 20a, 20b, 30, and 40 efficiency. For example, this difference can be less than 0.6 in one aspect (|n_{TF}−n_{sub}|<0.6), less than 0.25 in another aspect (|n_{TF}−n_{sub}|<0.25), less than 0.15 in another aspect (|n_{TF}−n_{sub}|<0.15), or less than 0.05 in another aspect (|n_{TF}−n_{sub}|<0.05).

It can also be beneficial, for improving dielectric PBS 20a, 20b, 30, and 40 efficiency, for one of the following two conditions (3 or 4) to be satisfied:
3. A large difference between an index of refraction n_{TF} of the thin-film-layer 12 and an effective index of refraction n_{∥} of the grating-layer 13 for a polarization parallel to a length L of the regions 13_{H} and 13_{L} AND a small difference between the index of refraction n_{TF} of the thin-film-layer 12 and an effective index of refraction n_{⊥} of the grating-layer 13 for a polarization perpendicular to a length L of the regions 13_{H} and 13_{L}. For example, the grating-layer 13 and thin-film-layer 12 can satisfy the equations:

|n_{TF}−n_{∥}|>0.3, |n_{TF}−n_{∥}|>0.45, |n_{TF}−n_{∥}|>0.6, |n_{TF}−n_{∥}|>0.7, or |n_{TF}−n_{∥}|>0.8, and a.

|n_{TF}−n_{⊥}|<0.25, |n_{TF}−n_{⊥}|<0.2, |n_{TF}−n_{⊥}|<0.15, |n_{TF}−n_{⊥}|<0.1, or |n_{TF}−n_{⊥}|<0.05. b.
4. A large difference between an index of refraction n_{TF} of the thin-film-layer 12 and an effective index of refraction n_{⊥} of the grating-layer 13 for a polarization perpendicular to a length L of the regions 13_{H} and 13_{L} AND a small difference between the index of refraction n_{TF} of the thin-film-layer 12 and an effective index of refraction n_{∥} of the grating-layer 13 for a polarization parallel to a length L of the regions 13_{H} and 13_{L}. For example, the grating-layer 13 and thin-film-layer 12 can satisfy the equations:

|n_{TF}−n_{⊥}|>0.3, |n_{TF}−n_{⊥}|>0.45, |n_{TF}−n_{⊥}|>0.6, |n_{TF}−n_{⊥}|>0.7, or |n_{TF}−n_{⊥}|>0.8, and a.

|n_{TF}−n_{∥}|<0.25, |n_{TF}−n_{∥}|<0.2, |n_{TF}−n_{∥}|<0.15, |n_{TF}−n_{∥}|<0.1, or |n_{TF}−n_{∥}|<0.05. b.

Duty cycle (W_{H}/P), n_{TF}, n_{H}, and n_{L} can be selected to achieve desired relationships in equations 3.a, 3.b, 4.a, and 4.b above.

The thin-film-layer 12 can have isotropic optical properties throughout the thin-film-layer. The thin-film-layer 12 can be isotropic in the y direction (along a length L of the regions 13_{H} and 13_{L}) and in the x direction (perpendicular to the length L of the regions 13_{H} and 13_{L}). The thin-film-layer 12 can consist of a single material (e.g. a substantially, homogeneous layer of silicon dioxide). The grating-layer 13 can be isotropic in the y direction (along a length L of the regions 13_{H} and 13_{L}) but anisotropic in the x direction (perpendicular to the length L of the regions 13_{H} and 13_{L}) due to different materials of the low index regions 13_{L} compared to the high index regions 13_{H}.

A grating-layer 13 can adjoin the substrate 11 and can be sandwiched between a thin-film-layer 12 and the substrate 11, as shown in FIG. 2a. A thin-film-layer 12 can adjoin the substrate 11 and can be sandwiched between a grating-layer 13 and the substrate 11, as shown in FIG. 2b. Within the grating-layer 13, the high-index regions 13_{H} can contact or adjoin the low-index regions 13_{L}. A choice of the above relationships can be made to optimize each dielectric PBS design.

For some applications, PBS performance can be improved by addition of a grid layer 32 located between the grating-layer 13 and the thin-film-layer 12 (see FIG. 3). The grid layer 32 can include an array of elongated, substantially-parallel ribs 32ᵣ. Each rib 32ᵣ can be located between each high-index region 13_{H} and the thin-film-layer 12 as shown, or between each low-index region 13_{L} and the thin-film-layer 12 (not shown). The grid layer 32 can be made of the same material as the thin-film-layer 12. The grid layer 32 can be formed by using the high-index regions 13_{H} or the low-index regions 13_{L} as a mask to etch the thin-film-layer 12. In one embodiment, the grid layer 32 can have a thickness 32_{Th} of between 10 and 60 nanometers.

As shown in FIGS. 4-5, a grating-layer 13 and a thin-film-layer 12 together can comprise a pair 43. The PBS 40 can further comprise at least one additional pair 43 in one aspect or at least two additional pairs 43 in another aspect. The PBS 40 can include at least one and less than fifteen pairs 43 in another aspect. Efficiency can be improved by multiple pairs 43. Imperfections in relationships between the effective indices of refraction n_{⊥} & n_{∥} of the grating-layer 13, the index of refraction n_{TF} of the thin-film-layer 12, and the index of refraction n_{sub} of the substrate 11 can be compensated for by additional pairs 43. Adding more pairs 43 can increase cost, so it can be preferable to optimize relationships between the indices of refraction as much as possible, then add more pairs 43 as needed.

Material of the substrate 11, the grating-layer 13, the grid layer 32, and/or the thin-film-layer 12 can be dielectric, and can be non-polymer dielectric materials. Examples of dielectric materials include Na₃AlF₆, MgF₂, ZnS, titanium oxide, SiO₂, Al₂O₃, and HfO₂. It can be beneficial for material of the substrate 11, the grating-layer 13, the grid layer 32, and/or the thin-film-layer 12 to have a k value portion of an index of refraction, in the light spectrum of designed use, that is small. For example, the k value can be less than 0.1 in one aspect, less than 0.05 in another aspect, less than 0.03 in another aspect, or less than 0.01 in another aspect. The k value can be less than these values at one point in the spectrum of designed use or throughout the spectrum of designed use (e.g. from 400 through 700 nanometers).

Other aspects of PBS 10, 20a, 20b, 30, and 40 design can be modified in order to optimize performance for each particular design. For example, as shown in FIG. 1, a thickness 13_{LTh} of the low-index regions 13_{L} can be the same as a thickness 13_{HTh} of the high-index regions 13_{H} (thus, the grating-layer 13 can have a single thickness 13_{Th}). As shown in FIG. 1, a top surface of the low-index regions 13_{H} and a top surface of the high-index regions 13_{H} can terminate in a common plane 13_{PT}. As shown in FIG. 1, a bottom surface of the low-index regions 13_{L} and a bottom surface of the high-index regions 13_{H} terminate in a common plane 13_{PB}. As shown in FIG. 3, a thickness 13_{LTh} of the low-index regions 13_{L} can be greater than a thickness 13_{HTh} of the high-index regions 13_{H}. Although not shown, a thickness 13_{LTh} of the low-index regions 13_{L} can be less than a thickness 13_{HTh} of the high-index regions 13_{H}.

It can be beneficial, if it is desirable to minimize high order diffractions, to have a pitch P that is less than, or less than one-half of, a lowest wavelength in the wavelength spectrum of use. For example, for use in visible light, the pitch P can be less than 400 nanometers in one aspect or less than 200 nanometers in another aspect.

It can be beneficial for minimization of high order diffractions to have a width W_{L} of the low-index regions 13_{L} and/or a width W_{H} of the high-index regions 13_{H} that are less than, or less than one-half of, a lowest wavelength in the wavelength spectrum of use (see FIGS. 4-5). For example, for use in visible light, a width W_{L} of the low-index regions 13_{L} and/or a width W_{H} of the high-index regions 13_{H} can be less than 400 nanometers in one aspect, less than 200 nanometers in another aspect, less than 100 nanometers in another aspect, or less than 60 nanometers in another aspect.

The grating-layer 13 and the thin-film-layer 12 can be optical thin films. For example, the grating-layer 13 have a thickness 13_{Th} and the thin-film-layer 12 can have a thickness 12_{Th} of less than 1 wavelength in one aspect or less than ½ wavelength in another aspect, for light in a wavelength range of designed PBS use. The grating-layer 13 have a thickness 13_{Th} and the thin-film-layer 12 can have a thickness 12_{Th} of less than 400 nanometers in another aspect.

The dielectric PBS 10, 20a, 20b, 30, and 40 described herein can be located in a glass cube, and thus can have advantages of prisms including short back focal length, durability, and ease of assembly into an optical system, but can also polarize a much larger range of light incident angles than a MacNeille prism. The dielectric PBS 10, 20a, 20b, 30, 40 described herein can have improved efficiency over other wire grid polarizing beam splitter designs.

### Light-Beam Splitting System and Method of Use

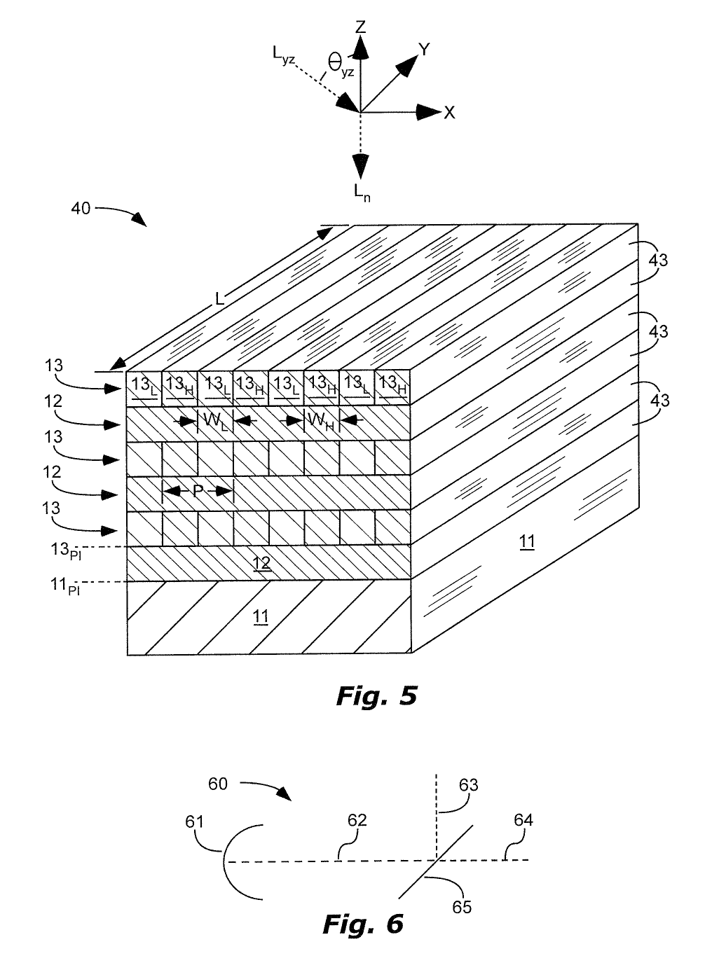

Shown in FIG. 6 is a light-beam splitting system 60. A light source 61 can be located to shine light 62 (e.g. visible light) on a PBS 65, which can be made according to one of the embodiments described herein. The PBS 65 can split the light 62 into a transmitted beam 64 (which can include primarily one polarization, e.g. p-polarized light) and a reflected beam 63 (which can include primarily an opposite polarization, e.g. s-polarized light). It would be ideal for the incoming light 62 to equal the transmitted beam 64 plus the reflected beam 63 (light 62=transmitted beam 64+reflected beam 63). Due to absorption, however, the incoming light 62 can be greater than the transmitted beam 64 plus the reflected beam 63 (light 62>transmitted beam 64+reflected beam 63). Consequently, a larger, more powerful, more expensive light source 61 may be needed, and there may be increased cooling requirements, which can result in increased and undesirable cost, weight, size, and noise of the system 60. Thus, it can be beneficial to minimize absorption and to approach closer towards the ideal of the incoming light 62 being equal the transmitted beam 64 plus the reflected beam 63.

By making the PBS 65 out of all or substantially all dielectric materials, absorption can be minimized. Thus, for example, at least 90% of incident light 62 on the PBS can be reflected off of or transmitted through the PBS 65 in one aspect (0.9*light 62≦reflected beam 63+transmitted beam 64), at least 95% of incident light 62 on the PBS can be reflected off of or transmitted through the PBS 65 in another aspect, at least 98% of incident light 62 on the PBS can be reflected off of or transmitted through the PBS 65 in another aspect, at least 99% of incident light 62 on the PBS can be reflected off of or transmitted through the PBS 65 in another aspect.

A method of using one of the PBS 10, 20a, 20b, 30 or 40 described herein can include the following steps:
1. locating the PBS 10, 20a, 20b, 30 or 40 in a light source 61; and
2. transmitting or reflecting at least 90% of incident light 62 in one aspect, transmitting or reflecting at least 95% of incident light in another aspect, transmitting or reflecting at least 98% of incident light in another aspect, or transmitting or reflecting at least 99% of incident light in another aspect.

### Example Designs

Following is an example design of a plate dielectric PBS designed for 550 nanometer wavelength light L_{xz} incident from air at angle θ_{xz}=45°:
1. High-index regions 13_{H} are TiO₂ with n_{H}≈2.58 and low-index regions 13_{L} are air with n_{L}≈1.0. n_{H}−n_{L}=1.58.
2. Thin-film-layer 12 is MgF₂ with n_{TF}≈1.38.
3. Substrate 11 is borofloat glass plate with n_{sub}=1.50.
4. Pitch=144 nanometers.
5. Duty cycle (W_{H}/P)=65%.
6. For normal incident light Lₙ: n_{∥}=2.17 & n_{⊥}=1.50.
7. For non-normal incident light L_{xz} at angle 45° along the x-z plane: n_{∥}(45°)=2.17 & n_{⊥}(45°)=1.58.
8. |n_{TF}−n_{⊥}|=0.20 and |n_{sub}−n_{⊥}|=0.
9. |n_{TF}−n_{∥}|=0.79 and |n_{sub}−n_{∥}|=0.67.
10. |n_{TF}−n_{sub}|=0.12.

Following is an example design of a cube dielectric PBS designed for broadband, visible light L_{yz} incident from glass at angle θ_{yz}=45°:
1. High-index regions 13_{H} are TiO₂ with n_{H}≈2.58 and low-index regions 13_{L} are spin-on-glass with n_{L}≈1.17. n_{H}−n_{L}=1.41.
2. Thin-film-layer 12 is HfO₂ with n_{TF}≈1.93.
3. Substrate 11 is glass with n_{sub}≈1.88. Incident medium is also glass with n_{sub}≈1.88.
4. Pitch=120 nanometers.
5. Duty cycle (W_{H}/P)=40%.
6. For normal incident light Lₙ: n_{∥}=1.87 & n_{⊥}=1.42.
7. For non-normal incident light L_{yz} at angle 45° along the x-z plane: n_{∥}(45°)=1.87 & n_{⊥}(45°)=1.42.
8. |n_{TF}−n_{⊥}=0.51 and |n_{sub}−n_{⊥}|=0.46.
9. |n_{TF}−n_{∥}|=0.06 and |n_{TF}−n_{∥}|=0.01.
10. |n_{TF}−n_{sub}|=0.05.

### Summary of Design

In summary of the design considerations discussed above, a PBS with benefits of a broad range of light incident angles, high transmission of one polarization (e.g. high Tp), high or controlled reflection of an opposite polarization (e.g. high Rs, or control Rs to a desired value), high efficiency, short back-focal-length in an optical system, low light absorption, and/or ease of assembly into an optical system, can be made by the following design considerations:

First, the beam splitter can be made mostly, substantially, or entirely of dielectric materials that are substantially transmissive to light in the wavelength range of use (e.g. low k value).

Second, the beam splitter can include at least one grating-layer 13. The grating-layer 13 can include an array of elongated, substantially-parallel, alternating high-index regions 13_{H} and low-index regions 13_{L}. Improved performance may be obtained by large differences between indices of refraction of these two regions 13_{H} and 13_{L} (i.e. large n_{H}−n_{L}).

Third, design for large |n_{TF}−n_{⊥}| and small |n_{TF}−n_{∥}| OR small |n_{TF}−n_{⊥}| and large |n_{TF}−n_{∥}| if a thin-film-layer 12 is used. If a thin-film-layer 12 is not used, then design for large |n_{sub}−n_{⊥}| and small |n_{sub}−n_{∥}| OR small |n_{sub}−n_{⊥}| and large |n_{sub}−n_{∥}|. The small difference between n_{TF}/n_{sub} and n_{⊥} or n_{∥} allows one polarization to pass through with minimal reflection at layer boundaries. In theory, if n_{TF}/n_{sub}=n_{⊥} or n_{TF}=n_{∥}/n_{sub}, then there will be no reflection of this polarization at boundaries between the thin-film-layer 12 and the grating-layer 13. The large difference between n_{TF}/n_{sub} and n_{⊥} or n_{∥} can cause a high reflection of the other polarization. In theory, it is beneficial to make this difference as large as possible.

Fourth, design for a small |n_{TF}−n_{sub}|. This allows any boundary between the substrate and the thin-film-layer 12 or the grating-layer 13 to cause minimal reflection of this polarization. In theory, it is optimal if n_{TF}=n_{sub}.

In practical design, because materials lack ideal properties, there may be tradeoffs. One design might optimize primarily for transmission of one polarization but sacrifice another desired characteristic. Another design might optimize primarily for reflection of one polarization but sacrifice another desired characteristic.

Due to imperfections in available materials, and imperfections in manufacturing, actual designs typically do not meet the ideal. Thus, the terms “large” and “small” are relative, as shown in example designs above. Such imperfections can be at least partially compensated for by increasing the number of pairs 43. Increasing the number of pairs 43, however, can increase manufacturing cost, so there may be a tradeoff between increasing performance and avoiding polarizer cost increase.

### Method of Making

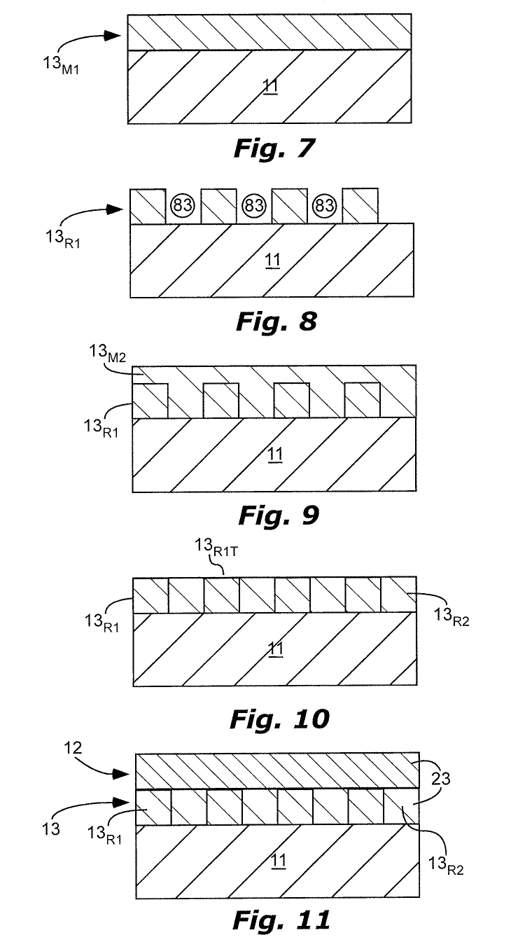

A first method of making a dielectric PBS can comprise some or all of the following steps (steps 1 & 2 can be done in any order and step 3 can follow steps 1-2):
1. Form a grating-layer 13 by the following steps a-c in order:
   a. Form an array of parallel, first regions 13_{R1} over a substrate 11. For example, sputter a material 13_{M1} on the substrate 11 (see FIG. 7) then pattern and etch the material 13_{M1} to form the first regions 13_{R1} (see FIG. 8). If it is desired to make a grid layer 32, then the first regions 13_{R1} can be used as a mask and to etch into underlying material (e.g. thin-film-layer 12 or the substrate 11).
   b. Fill elongated trenches 83 between the first regions 13_{R1} and above the first regions 13_{R1} with a second material 13_{M2} (e.g. by spin-on or ALD). See FIGS. 8-9.
   c. Etch the second material 13_{M2} to form second regions 13_{R2} in the trenches 83 and so that tops 13_{R1T} of the first regions 13_{R1} are substantially free of the second material 13_{M2}. See FIGS. 9-10.
2. Form a thin-film-layer 12 (e.g. by sputter) over a surface of a substrate 11. See FIG. 11.
3. Repeat steps 1-2 (this step 3 can be repeated multiple times).
   Either the first regions 13_{R1} or the second regions 13_{R2} can be high-index regions 13_{H} and the other of the first regions 13_{R1} or the second regions 13_{R2} can be low-index regions 13_{L}.

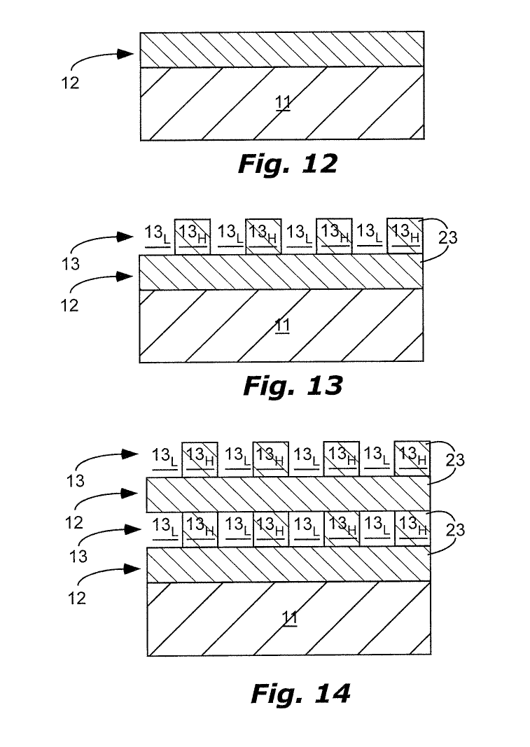

A second method of making a dielectric PBS can comprise some or all of the following steps (steps 1 & 2 can be done in any order and step 3 can follow steps 1-2):
1. Form a thin-film-layer 12 (e.g. by sputter) over a surface of a substrate 11. See FIG. 12.
2. Form a grating-layer 13 by forming an array of parallel, elongated high-index-regions 13_{H} over a surface of a substrate 11. For example, sputter a material of the high-index-regions 13_{H} on the substrate 11, then pattern and etch to form the high-index-regions 13_{H}. If it is desired to make a grid layer 32, as shown in FIG. 3, then the high-index-regions 13_{H} can be used as a mask and to etch into the thin-film-layer 12. Air-filled trenches between the high-index-regions 13_{H} can be the low-index regions 13_{L}. See FIG. 13.
3. Repeat steps 1-2 (this step 3 can be repeated multiple times). See FIG. 14. It can be difficult to deposit a thin-film-layer 12 over the grating-layer 13 without filling the low-index regions 13_{L} with material of the thin-film-layer. Deposition at a very oblique angle (e.g. 80°) or methods described in US Patent Publication Number US 2012/0075699, incorporated herein by reference, can be used to minimize filling the low-index regions 13_{L} with material of the thin-film-layer 12.

What is claimed is:

1. A dielectric polarizing beam splitter (PBS) comprising:
a. a substrate having a substantially planar surface;
b. a grating-layer and a thin-film-layer disposed over the planar surface of the substrate;
c. the grating-layer including an array of elongated, substantially-parallel, alternating high-index regions and low-index regions;
d. the grating-layer being disposed in a plane substantially parallel with the planar surface of the substrate;
e. an index of refraction (n_{L}) of the low-index-regions is less than an index of refraction (n_{H}) of the high-index-regions;
f. the grating-layer and the thin-film-layer satisfy the equations:
i. |n_{TF}−n_{∥}|>0.7 and |n_{TF}−n_{⊥}|<0.25; or
ii. |n_{TF}−n_{⊥}|>0.7 and |n_{TF}−n_{∥}|<0.25;
iii. where:
1. n_{TF} is an index of refraction of the thin-film-layer;
2. n_{∥} an effective index of refraction of the grating-layer for a polarization parallel to a length of the high-index-regions and low-index-regions;
3. n_{⊥} is an effective index of refraction of the grating-layer for a polarization perpendicular to a length of the high-index-regions and low-index-regions; and
4. n_{TF} is an index of refraction of the thin-film-layer; and
g. material of the grating-layer is dielectric and material of the thin-film-layer is dielectric.

2. A dielectric polarizing beam splitter (PBS) comprising:
a. a substrate having a substantially planar surface;
b. a grating-layer and a thin-film-layer disposed over the planar surface of the substrate;
c. the grating-layer including an array of elongated, substantially-parallel, alternating high-index regions and low-index regions;
d. the grating-layer being disposed in a plane substantially parallel with the planar surface of the substrate;
e. an index of refraction (n_{L}) of the low-index-regions is less than an index of refraction (n_{H}) of the high-index-regions;
f. the grating-layer and the thin-film-layer satisfy the equations:
i. |n_{TF}−n_{∥}|>0.45 and |n_{TF}−n_{⊥}|<0.1; or
ii. |n_{TF}−n_{⊥}|>0.45 and |n_{TF}−n_{∥}|<0.1;
iii. where:
1. n_{TF} is an index of refraction of the thin-film-layer;
2. n_{∥} an effective index of refraction of the grating-layer for a polarization parallel to a length of the high-index-regions and low-index-regions;
3. n_{⊥} is an effective index of refraction of the grating-layer for a polarization perpendicular to a length of the high-index-regions and low-index-regions; and
4. n_{TF} is an index of refraction of the thin-film-layer; and
g. materials of the grating-layer and of the thin-film-layer are dielectric materials having a k value portion of an index of refraction that is less than 0.05.

3. The PBS of claim 2, wherein the index of refraction (n_{L}) of the low-index-regions and the index of refraction (n_{H}) of the high-index-regions satisfy the equation: n_{H}−n_{L}>1.3.

4. A dielectric polarizing beam splitter (PBS) comprising:
a. a substrate having a substantially planar surface;
b. a grating-layer and a thin-film-layer disposed over the planar surface of the substrate;
c. the grating-layer including an array of elongated, substantially-parallel, alternating high-index regions and low-index regions;
d. the grating-layer being disposed in a plane substantially parallel with the planar surface of the substrate;
e. an index of refraction (n_{L}) of the low-index-regions is less than an index of refraction (n_{H}) of the high-index-regions; and
f. material of the grating-layer is dielectric and material of the thin-film-layer is dielectric.

5. The PBS of claim 4, wherein the index of refraction (n_{L}) of the low-index-regions and the index of refraction (n_{H}) of the high-index-regions satisfy the equation: n_{H}−n_{L}>1.5.

6. The PBS of claim 4, wherein the index of refraction (n_{L}) of the low-index-regions and the index of refraction (n_{H}) of the high-index-regions satisfy the equation: n_{H}−n_{L}>1.3.

7. The PBS of claim 4, wherein the grating-layer and the thin-film-layer satisfy the equations:
a. |n_{TF}−n_{∥}|>0.7 and |n_{TF}−n_{⊥}|<0.25; or
b. |n_{TF}−n_{⊥}|>0.7 and |n_{TF}−n_{∥}|<0.25;
c. where:
i.
$${n}_{‖} = {( \frac{{W}_{L}}{P} * {n}_{L}^{2} + \frac{{W}_{H}}{P} * {n}_{H}^{2} )}^{1 / 2}$$
for normal incident light;
ii.
$${n}_{⊥} = {( \frac{{W}_{L}}{P} * \frac{1}{{n}_{L}^{2}} + \frac{{W}_{H}}{P} * \frac{1}{{n}_{H}^{2}} )}^{- 1 / 2}$$
for normal incident light;
iii. n_{TF} is an index of refraction of the thin-film-layer;
iv. W_{L} is a width of the low-index-regions;
v. W_{H} is a width of the high-index-regions; and
vi. P is a pitch of the high-index-regions.

8. The PBS of claim 4, wherein the grating-layer and the thin-film-layer satisfy the equations:
a. |n_{TF}−n_{∥}|>0.45 and |n_{TF}−n_{⊥}|0.1; or
b. |n_{TF}−n_{⊥}|>0.45 and |n_{TF}−n_{∥}|<0.1;
c. where:
i.
$${n}_{‖} = {( \frac{{W}_{L}}{P} * {n}_{L}^{2} + \frac{{W}_{H}}{P} * {n}_{H}^{2} )}^{1 / 2}$$
for normal incident light;
ii.
$${n}_{⊥} = {( \frac{{W}_{L}}{P} * \frac{1}{{n}_{L}^{2}} + \frac{{W}_{H}}{P} * \frac{1}{{n}_{H}^{2}} )}^{- 1 / 2}$$
for normal incident light;
iii. n_{TF} is an index of refraction of the thin-film-layer;
iv. W_{L} is a width of the low-index-regions;
v. W_{H} is a width of the high-index-regions; and
vi. P is a pitch of the high-index-regions.

9. The PBS of claim 4, wherein the grating-layer and the thin-film-layer satisfy the equations:
a. |n_{TF}−n_{∥}|>0.7 and |n_{TF}−n_{⊥}|<0.25; or
b. |n_{TF}−n_{⊥}|>0.7 and |n_{TF}−n_{∥}|<0.25;
c. where:
i. n_{TF} is an index of refraction of the thin-film-layer;
ii. n_{∥} an effective index of refraction of the grating-layer for a polarization parallel to a length of the high-index-regions and low-index-regions;
iii. n_{⊥} is an effective index of refraction of the grating-layer for a polarization perpendicular to a length of the high-index-regions and low-index-regions; and
iv. n_{TF} is an index of refraction of the thin-film-layer.

10. The PBS of claim 4, wherein the grating-layer and the thin-film-layer satisfy the equations:
a. |n_{TF}−n_{∥}|>0.45 and |n_{TF}−n_{⊥}|<0.1; or
b. |n_{TF}−n_{⊥}|>0.45 and |n_{TF}−n_{∥}|<0.1;
c. where:
i. n_{TF} is an index of refraction of the thin-film-layer;
ii. n_{∥} an effective index of refraction of the grating-layer for a polarization parallel to a length of the high-index-regions and low-index-regions;
iii. n_{⊥} is an effective index of refraction of the grating-layer for a polarization perpendicular to a length of the high-index-regions and low-index-regions; and
iv. n_{TF} is an index of refraction of the thin-film-layer.

11. The PBS of claim 4, wherein the thin-film-layer and the substrate satisfy the equation: |n_{TF}−n_{sub}|0.15, where:
a. n_{TF} is an index of refraction of the thin-film-layer; and
b. n_{sub} is an index of refraction of the substrate.

12. The PBS of claim 4, wherein materials of the substrate, the grating-layer, and the thin-film-layer are dielectric materials having a k value portion of an index of refraction that is less than 0.03.

13. The PBS of claim 4, wherein materials of the substrate, the grating-layer, and the thin-film-layer are non-polymer dielectric materials.

14. The PBS of claim 4, wherein:
a. the grating-layer and the thin-film-layer together comprise a pair; and
b. the PBS further comprises at least two additional pairs.

15. The PBS of claim 4, wherein:
a. the grating-layer and the thin-film-layer comprise a pair; and
b. the PBS includes at least one and less than fifteen pairs.

16. The PBS of claim 4, wherein the grating-layer contacts the thin-film-layer.

17. A polarizing beam splitter (PBS), for the visible spectrum, comprising:
a. a grating-layer disposed over a substantially planar surface of a substrate;
b. the grating-layer including an array of elongated, substantially-parallel, alternating high-index regions and low-index regions;
c. the grating-layer being disposed in a plane substantially parallel with the planar surface of the substrate;
d. an index of refraction (n_{L}) of the low-index-regions and an index of refraction (n_{H}) of the high-index-regions satisfy the equation from 400 through 700 nanometers: n_{H}−n_{L}>1.3; and
e. materials of the grating-layer are dielectric.

18. A method of using the PBS of claim 17, the method comprising:
a. disposing the PBS in a visible light source; and
b. transmitting or reflecting at least 95% of incident visible light.

19. The PBS of claim 17, wherein:
a. a top surface of the low-index regions and a top surface of the high-index regions terminate in a common plane; and
b. a bottom surface of the low-index regions and a bottom surface of the high-index regions terminate in a common plane.

20. The PBS of claim 17, wherein materials of the grating-layer have k values that are less than 0.01 from 400 through 700 nanometers.
